(19) United States
(12) Patent Application Publication
(10) Pub. No.: US 2024/0367745 A1
(43) Pub. Date: Nov. 7, 2024

(54) TRIKE-SHOPPING CART TRANSFORMER

(71) Applicant: Wichita State University, Wichita, KS (US)

(72) Inventors: Ikramuddin Ahmed, Wichita, KS (US); Cameron Gillespie, Wichita, KS (US); Grant Hutchings, Wichita, KS (US); Richard Oswalt, Wichita, KS (US); Ryan Walter, Wichita, KS (US)

(21) Appl. No.: 18/656,100

(22) Filed: May 6, 2024

Related U.S. Application Data
(60) Provisional application No. 63/500,203, filed on May 4, 2023.

(51) Int. Cl. B62K 13/04; B62K 5/02; B62K 7/02

(52) U.S. Cl. CPC B62K 13/04; B62K 5/02; B62K 7/02

(57) ABSTRACT

A tri-wheel commuter device is convertible between a tricycle configuration and a three wheeled cart configuration. The tri-wheel commuter device has a pair of wheels, a drive wheel, a seat, a seat hanger, handlebars, at least one cupholder, and a basket assembly having left and right upper and lower baskets. The tri-wheel commuter device also has a first frame section, a second frame section, and a hinge, which allows for inline folding and unfolding of the tri-wheel commuter device between tricycle and three wheeled cart configurations. The configuration of the handlebars and the basket assembly allows for conversion.

### CROSS-REFERENCE TO RELATED APPLICATION

This application claims priority to U.S. Provisional Patent Application No. 63/500,203, which is hereby incorporated by reference in its entirety.

### FIELD

This disclosure generally pertains to an adaptable transportation vehicle which easily transitions between a shopping cart and tri-wheel commuting cart.

### BACKGROUND

In a world where fewer cities are truly walkable, commuting via car has become the societal norm whether shopping for groceries, food, clothing, medicine, or any other items a person may want or need to leave their house to obtain. Those with cars are often inconvenienced by the time spent searching for parking and fuel expenditures. However, many people are left without cars altogether, whether that be due to financial constraints or due to an effort to reduce their carbon footprint in an everchanging climate crisis. For those without cars, they are often left to improvise, finding creative ways to carry their items while riding a bicycle, scooter, skateboard, or longboard. Ordinarily to solve this common problem, innovators look toward creating new bags or straps to carry things with. However, no device has been created which cures the deficiencies of current modes of transportation by creating a new vehicle.

### SUMMARY

In an aspect, a tri-wheel commuter device is disclosed, the tri-wheel commuter device having a frame with a first frame section, a second frame section, and a hinge that connects the first frame section to the second frame section, such that the first frame section is rotatable in relation to the second frame section about the hinge. The tri-wheel commuter device also includes a drive wheel operatively mounted on the first frame section, and a pair of wheels operatively mounted on the second frame section. The first frame section is rotatable about the hinge in relation to the second frame section in order to adjust the tri-wheel commuter device between a tricycle configuration and a three-wheeled cart configuration.

Other aspects will be in part apparent and in part pointed out hereinafter.

### BRIEF DESCRIPTION OF THE DRAWINGS

FIG. 1 is a left elevation of a tri-wheel commuter device (TWCD), showing the TWCD in a tricycle configuration and showing the basket assembly thereof in a stowed configuration;

FIG. 2 is a left elevation of the TWCD, showing the TWCD in a three-wheeled cart (3WC) configuration and showing the basket assembly in an expanded configuration;

FIG. 3 is a perspective of the TWCD in the trike configuration with the basket assembly expanded;

FIG. 4 is a perspective similar to FIG. 3 but showing the TWCD in the 3WC configuration;

FIG. 5 is a perspective similar to FIG. 3 but showing the basket assembly stowed;

FIG. 6 is a perspective similar to FIG. 4 but showing the basket assembly stowed;

FIG. 7 is a left elevation of the TWCD in the trike configuration with the basket assembly expanded;

FIG. 8 is an elevation similar to FIG. 7 but showing the TWCD in the 3WC configuration;

FIG. 9 is an elevation similar to FIG. 7 but showing the basket assembly stowed;

FIG. 10 is an elevation similar to FIG. 8 but showing the basket assembly stowed;

FIG. 11 is top plan view of the TWCD in the trike configuration with the basket assembly expanded;

FIG. 12 is a top plan view similar to FIG. 11 but showing the TWCD in the 3WC configuration;

FIG. 13 is a top plan view similar to FIG. 11 but showing the basket assembly stowed;

FIG. 14 is a top plan view similar to FIG. 12 but showing the basket assembly stowed;

FIG. 15 is an exploded perspective of the TWCD;

FIG. 16 is a perspective of a subassembly of the TWCD including the frame and handlebars, showing the frame assembly in the 3WC configuration;

FIG. 17 is an elevation of the subassembly of FIG. 16 in the 3WC configuration;

FIG. 18 is a top plan view of the subassembly of FIG. 16 in the 3WC configuration.

Corresponding parts are given corresponding reference characters throughout the drawings.

### DETAILED DESCRIPTION

Very few cities in the United States are truly walkable, causing commuting via car to become the societal norm and, at times, a necessity. Despite this need, many people are without cars due to financial constraints or due to personal efforts to reduce their carbon footprint in an ever-changing climate crisis. For those without cars, they are often left to improvise, finding creative ways to carry their items while riding a bicycle, scooter, skateboard, or longboard. Despite this common issue, no device has been created which cures the deficiencies of current modes of transportation by creating a new vehicle. Therefore, a new vehicle is needed to increase accessibility of shopping and carless travel for every individual.

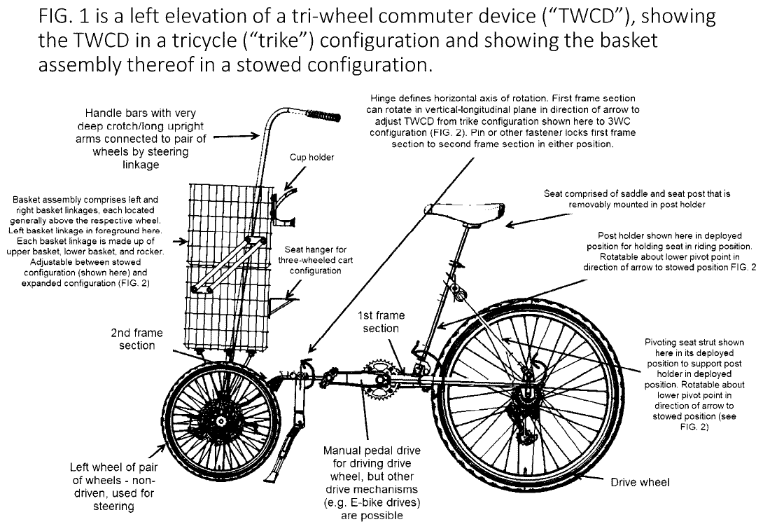

In an embodiment, as shown in FIG. 1, a tri-wheel commuter device 10 is disclosed, comprising a frame, a drive wheel 70, and a pair of wheels 55. This tri-wheel commuter device 10 is configured in such a manner which enables a user to easily use the device on bicycle and walking paths, as well as in stores during grocery shopping and other shopping tasks. The tri-wheel commuter device 10 is foldable and adaptable, utilizing an in-line, vertical folding mechanism.

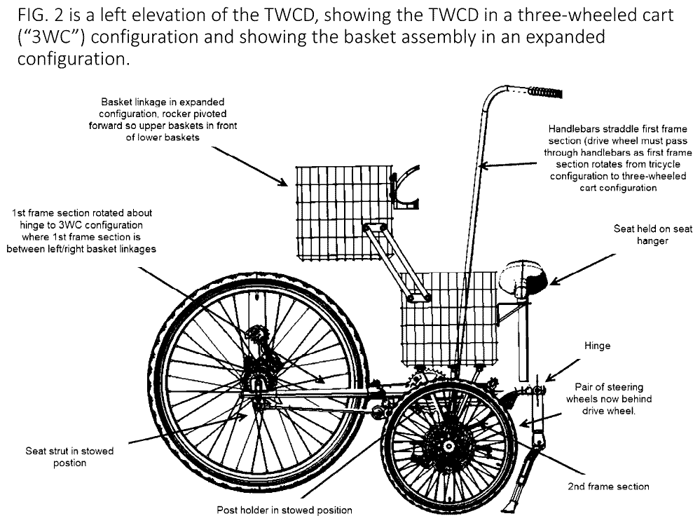

The frame comprises a first frame section 45, a second frame section 50, and a hinge 80 connecting the first frame section 45 to the second frame section 50. The hinge 80 is configured to connect the first frame section 45 to the second frame section 50 such that the first frame section 45 is rotatable in relation to the second frame section 50 about the hinge 80. Rotating the first frame section 45 about the hinge 80 in such a manner allows a user to adjust the tri-wheel commuter device 10 between a tricycle configuration (shown in FIG. 1) and a three-wheeled cart configuration (shown in FIG. 2). In the three-wheeled cart configuration, the tri-wheel commuter device is can easily go through standard checkout aisles in US grocery stores. Pins or any other type of fastener lock may be used to lock the first frame section 45 to the second frame section 50 in either configuration to enable user safety and security.

When the tri-wheel commuter device 10 is in the tricycle configuration, the hinge 80 defines a horizontal axis of rotation. The first frame section 45 is configured to rotate about the horizontal axis so that the first frame section 45 may move in a vertical/longitudinal plane perpendicular to the horizontal axis. Once the first frame section 45 has rotated such that it is approximately perpendicular to the horizontal axis, the tri-wheel commuter device 10 is now in the three-wheeled cart configuration shown in FIG. 2.

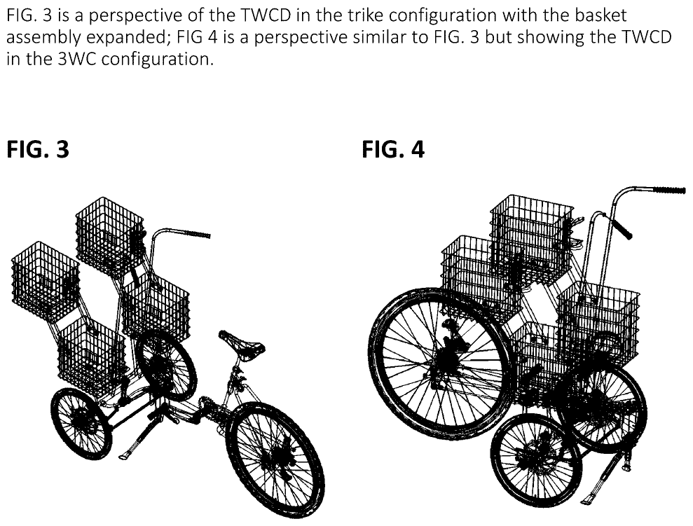

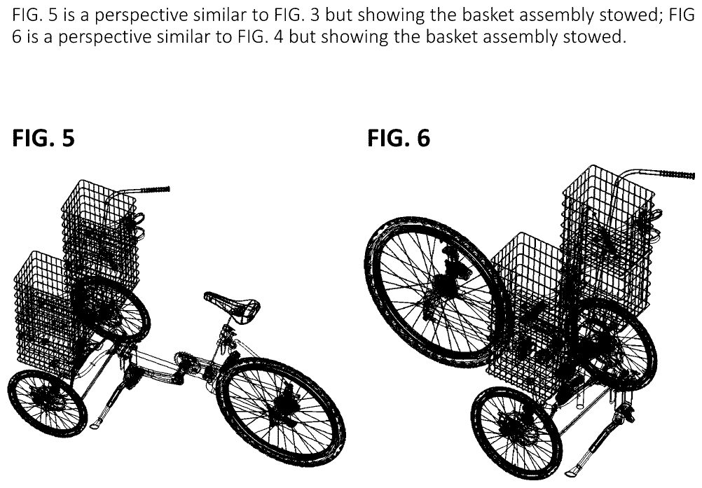

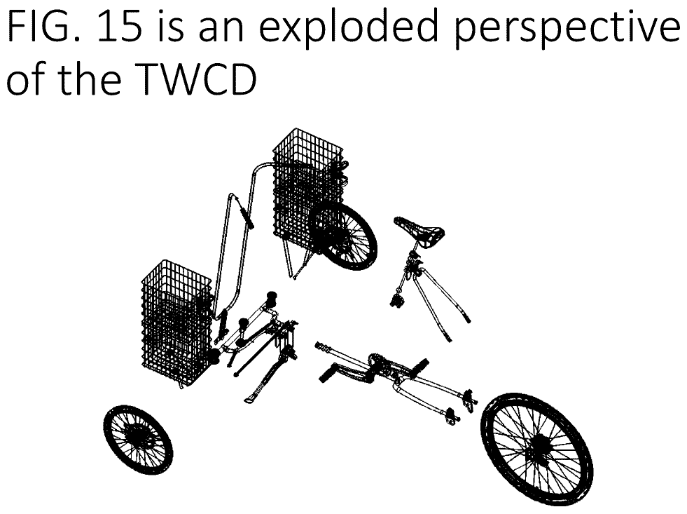

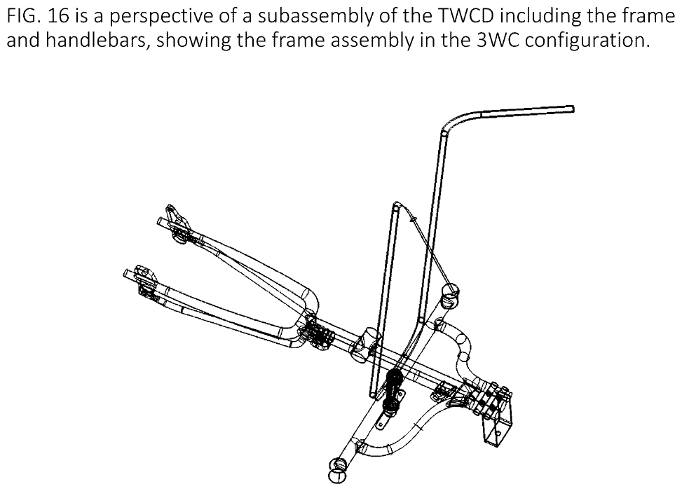

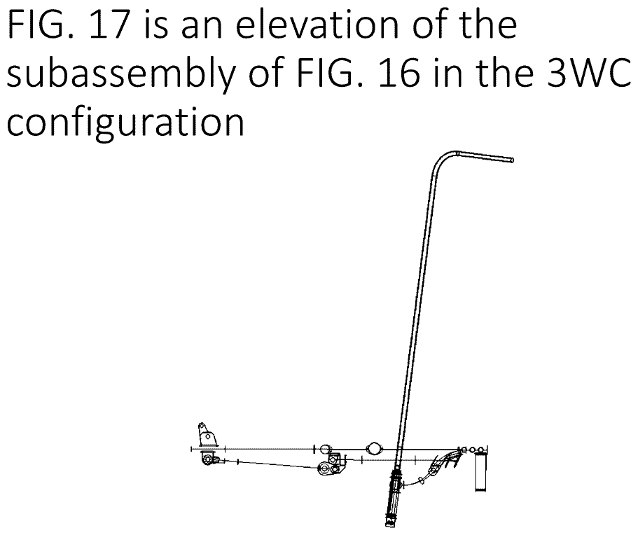

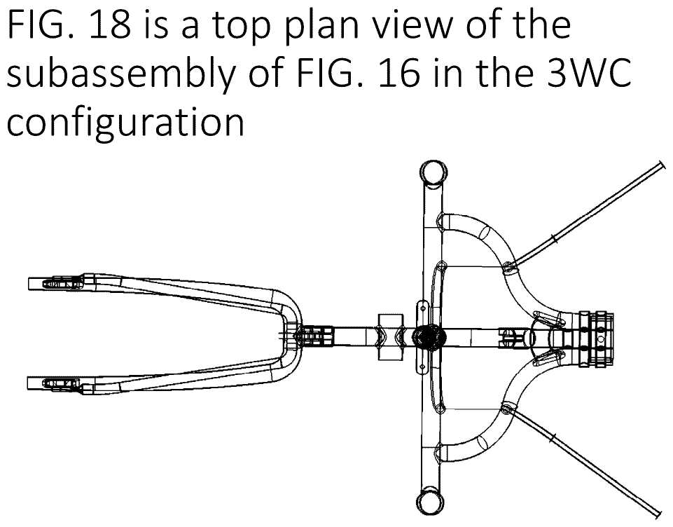

The tri-wheel commuter device 10 further comprises a seat 85 and at least one basket assembly 20. In an embodiment, the drive wheel 70 of the tri-wheel commuter device 10 is operatively coupled to the first frame section 45, and is located posterior and inferior to the seat 85 while in the tricycle configuration. Each wheel is configured such that the drive wheel 70 has a radius r₁ and the pair of wheels 55 (also known broadly as “steering wheels”) have a radius r₂, wherein r₁>r₂. While the tri-wheel commuter device 10 is in the tricycle configuration, the drive wheel 70 is located on the posterior portion of the tri-wheel commuter device 10, while the pair of wheels 55 is located on an anterior portion of the device. Alternatively, when the tri-wheel commuter device 10 has been converted to the three wheeled cart configuration, the drive wheel 70 becomes located anterior to the steering wheels 55, seat 85, and the rest of the tri-wheel commuter device 10. As depicted in greater detail in FIGS. 3-6 and 11-15, the pair of wheels 55 comprise a left wheel 60 and a right wheel 65.

The tri-wheel commuter device 10 further comprises handlebars 15 mounted on the second frame section 50. The handlebars 15 are operatively connected to the pair of wheels 55 such that they may be turned by a user's control of the handlebars 15 in order to continuously steer the tri-wheel commuter device 10 in a preferred direction. The handlebars 15 are connected to the pair of wheels 55 via a steering linkage. In several embodiments, the handlebars 15 are very long upright arms with a deep radius as depicted in FIG. 1. However, other styles of handlebars or steering systems may be used without departing from the scope of the present disclosure. While the tri-wheel commuter device 10 is in the three-wheeled cart configuration, the handlebars 15 are configured to straddle the first frame section 45 such that the drive wheel 70 passes through the handlebars 15 as the first frame section 45 rotates from the tricycle configuration to the three wheeled cart configuration.

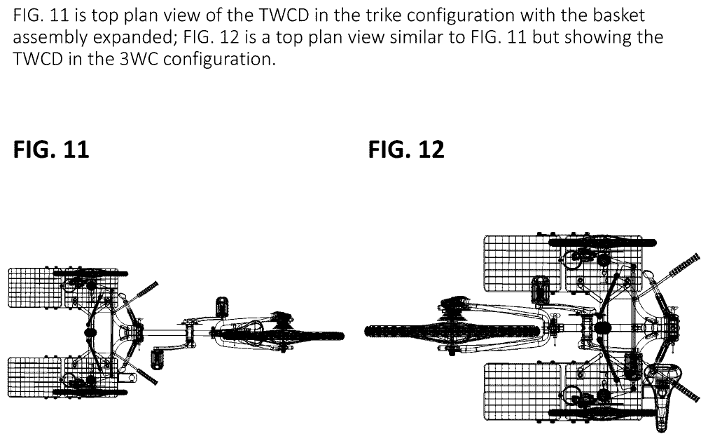

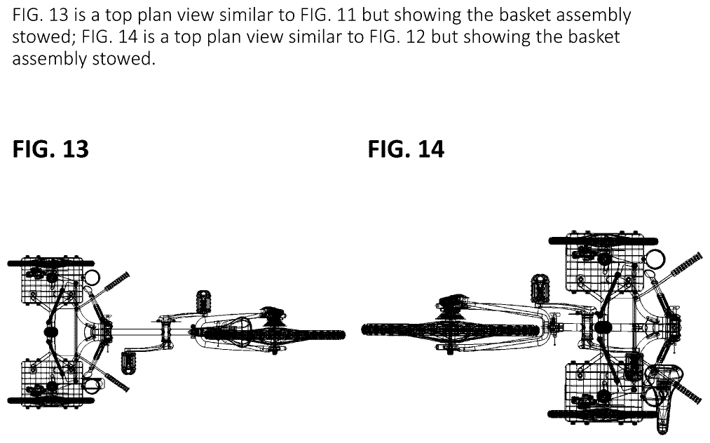

The tri-wheel commuter device 10 further comprises at least one basket assembly 20. The basket assembly 20 is mounted on the second frame section 50 and is configured to straddle the first frame section 45 when the tri-wheel commuter device 10 is in the three-wheeled cart configuration. The basket assembly 20 comprises a left basket linkage comprising a left upper basket 25 and a left lower basket 26, as well as a right basket linkage comprising a right upper basket 30 and a right lower basket 32. Each basket linkage further comprises a rocker. The rocker operatively connects the upper baskets to the lower baskets such that the entire basket assembly 20 is adjustable between a stowed configuration and an expanded configuration without the need to configure each basket individually. As shown in FIGS. 11-14, the left and right upper and lower baskets are configured such that in both the tricycle and three wheeled cart configurations, the left and right baskets 26, 32 are respectively aligned to be above the left and right wheels 60, 70.

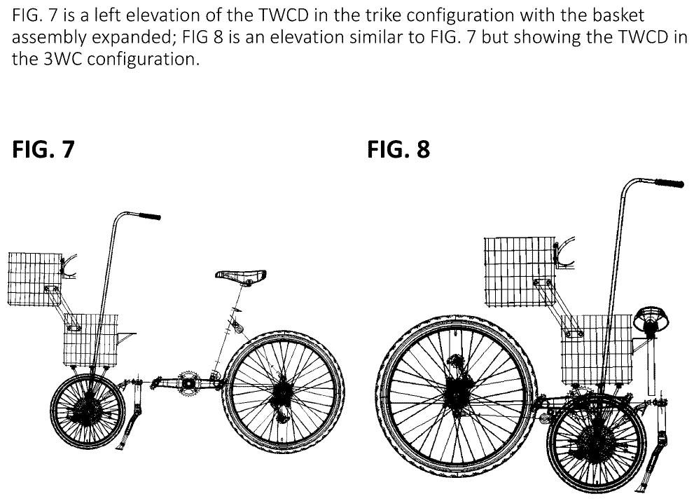

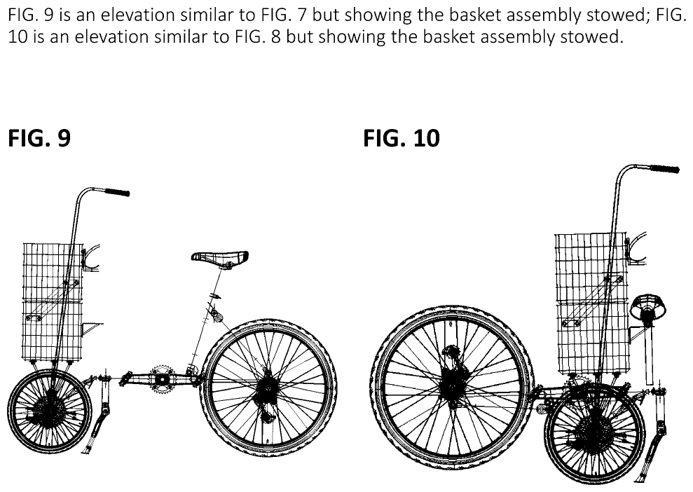

When the basket assembly 20 and linkages are in the stowed configuration, the tri-wheel commuter device 10 is in the tricycle configuration as shown in FIG. 1. In this configuration, the upper basket is located superior to the lower basket. An exemplary embodiment of this stowed configuration is depicted in FIGS. 9-10, as well as FIGS. 13-14. However, when in the expanded configuration as shown in FIG. 2, or the three wheeled cart configuration, the basket assembly 20 and linkages are in the expanded configuration and the rocker pivots forward such that upper baskets are located above and anterior to the lower baskets. This exemplary embodiment is shown in FIGS. 7-8, as well as FIGS. 11-12. In at least one embodiment, a seat hanger 40 is attached to the left lower basket 26 and is configured to store the seat 85 while in the three wheeled cart configuration. As shown in FIG. 12 which depicts an exemplary three wheeled cart embodiment, the seat 85 is removed from the frame 45 and is hung on the seat hanger 40 such that the anterior portion of the seat 85 is facing the left wheel 60. However, the seat 85 may be alternatively positioned within the seat hanger 40 in any orientation which does not interfere with the movement of the tri-wheel commuter device 10. A cup holder 35 is attached to the upper basket assembly 20 for holding user beverages, bottles, or cups. More specifically, in a primary embodiment, the cup holder 35 is fixed to the right upper basket 30 via pins or mechanical fasteners. The cupholder may either be a fixed size or expandable, as each option is within the spirit and scope of the present disclosure. In alternative embodiments, the cup holder may be affixed in such a way that allows the user to modify where the cup holder 35 is located on the tri-wheel commuter device. For example, moveable hooks known to those skilled in the art may be used for this purpose. It should be noted that both the seat hanger 40 and cupholder 35 may be moved and affixed to different locations within the tri-wheel commuter device 10 without departing from the scope of the present disclosure.

As noted above, the basket assembly 20 comprises at least one left basket linkage and at least one right basket linkage. Left and right basket linkages are configured to be located generally and respectively above one of the left or right steering wheels 60, 65 having a radius r₂.

As previously described, each basket linkage comprises an upper basket, a lower basket, and a rocker. When the tri-wheel commuter device 10 is in the three wheeled cart configuration, the first frame section 45 is located between the left basket linkage and right basket linkage. This location may also be described as being located in the middle of the left and right upper or lower baskets. Exemplary embodiments depicting such are shown in FIGS. 11 and 12, as well as in a perspective view within FIGS. 5 and 6.

The seat 85 of the tri-wheel commuter device 10 comprises a saddle and a seat post (not labeled), and further a seat strut 95 and a post holder 90. The seat strut 95 and post holder 90 are each pivotably connected to the first frame section 45 which allows for adjustment between expanded and stowed positions. More specifically, when the tri-wheel commuter device 10 is in the tricycle configuration, the seat strut 95 (FIG. 1) and post holder 90 are configured to support the seat 85 and the user in a riding position. An example of this is shown in FIG. 1. Conversely, when the tri-wheel commuter device 10 is in the three-wheeled cart configuration, as shown in FIG. 2, the seat strut 95 and post holder 90 are configured to be stowed between the first frame section 45 and the second frame section 50. In the tricycle configuration the seat 85 is removably mounted in the post holder 90 such that when the tri-wheel commuter device 10 is in the three wheeled cart configuration, the seat 85 may be easily detached and stored on the seat hanger 40 as shown in FIG. 2.

In a primary embodiment, the tri-wheel commuter device 10 further comprises a manual pedal drive 75 and pedals to enable a user to move the tri-wheel commuter device 10 forward while also allowing for exercise. Similarly, the manual pedal drive may be used to prevent the tri-wheel commuter device 10 from moving backward. In alternative embodiments, other driving and movement mechanisms may be used, such as an electric bike drive coupled to a battery for automation of power and increased speed capabilities. The battery used in alternative embodiments may be a lithium-ion battery as is known to those skilled in the art, but alternative power sources may be used without departing from the scope of the present disclosure. Alternative embodiments of the tri-wheel commuter device 10 may further comprise a hand or foot brake as is common in bicycles.

As is depicted in FIGS. 1-10 and FIG. 15, the tri-wheel commuter device 10 may further comprise a support leg 100. The support leg 100 is configured to be rotatably coupled to the first frame section 45 via the hinge 80. When in the tricycle configuration, the support leg 100 may be rotated such that it contacts the ground, as shown in FIG. 1. This orientation allows the support leg 100 to provide support which prevents the tri-wheel commuter device 10 from tipping left or right, no matter the weight contained within the basket assembly. Alternatively, when the tri-wheel commuter device is converted to the three wheeled cart configuration as shown in FIG. 2, the support leg 100 becomes located underneath the seat hanger 40 and behind the pair of wheels 55 such that when a user is shopping, the support leg prevents the tri-wheel commuter device 10 from involuntarily rolling forward or backward. In alternative embodiments, the tri-wheel commuter device 10 may instead be configured to have a pair of support legs 100 instead of a single support leg 100.

When introducing elements of the present disclosure or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

Further, it should be noted that use of the terms “primary embodiment” and “alternative embodiment” are not intended to be limiting, and instead are used to distinguish between embodiments pictured in the figures and other exemplary embodiments. As various changes could be made in the above products and methods without departing from the scope of the disclosure, it is intended that all matter contained in the above description shall be interpreted as illustrative and not in a limiting sense.

In view of the above, it will be seen that the several objects of the disclosure are achieved and other advantageous results attained.

What is claimed is:

1. A tri-wheel commuter device comprising:
a frame including a first frame section, a second frame section and a hinge connecting the first frame section to the second frame section such that the first frame section is rotatable in relation to the second frame section about the hinge;
a drive wheel operatively mounted on the first frame section;
a pair of wheels operatively mounted on the second frame section;
wherein the first frame section is rotatable about the hinge in relation to the second frame section to adjust the tri-wheel commuter device between a tricycle configuration and a three-wheeled cart configuration.

2. The tri-wheel commuter device of claim 1, wherein the hinge defines a horizontal axis of rotation, the first frame section configured to rotate about the horizontal axis of rotation in a vertical/longitudinal plane.

3. The tri-wheel commuter device of claim 1, further comprising handlebars mounted on the second frame section and operatively connected to the pair of wheels for steering the pair of wheels.

4. The tri-wheel commuter device of claim 3, wherein the handlebars are configured to straddle the first frame section when the tri-wheel commuter device is in the three-wheeled cart configuration.

5. The tri-wheel commuter device of claim 1, further comprising a basket assembly mounted on the second frame section.

6. The tri-wheel commuter device of claim 5, wherein the basket assembly is configured to straddle the first frame section when the tri-wheel commuter device is in the three-wheeled cart configuration.

7. The tri-wheel commuter device of claim 5, wherein the basket assembly comprises a basket linkage including an upper basket, a lower basket, and a rocker operatively connecting the upper basket to the lower basket such that the basket assembly is adjustable between a stowed configuration and an expanded configuration.

8. The tri-wheel commuter device of claim 7, wherein in the stowed configuration the upper basket is above the lower basket and wherein in the expanded configuration, the upper basket is in front of the lower basket.

9. The tri-wheel commuter device of claim 5, wherein the basket assembly comprises a left basket linkage and a right basket linkage, the first frame section being located between the left basket linkage and the right basket linkage in the three-wheeled cart configuration.

10. The tri-wheel commuter device of claim 1, further comprising a seat comprising a saddle and a seat post.

11. The tri-wheel commuter device of claim 10, further comprising a seat strut and a post holder each pivotably connected to the first frame section for adjusting between respective deployed positions and respective stowed positions, wherein when the tri-wheel commuter device is in the tricycle configuration, the seat strut and post holder in the respective deployed configurations are configured to support the seat in a riding position, and wherein when the tri-wheel commuter device is in the three-wheeled cart configuration, the seat strut and post holder in the respective stowed configurations are configured to be stowed between the first frame section and the second frame section.
